(19) United States
(12) Patent Application Publication
(10) Pub. No.: US 2003/0101107 A1
(43) Pub. Date: May 29, 2003

(54) Inventory management system and method

(76) Inventors: Rishi Agarwal, San Francisco, CA (US); Talbot S. Smith, Sumerset, NJ (US); Tanvir Hassan, Alameda, CA (US); Apostolos Burnetas, Cleveland Heights, OH (US); Sumitha Sampath, Union City, CA (US); Bharath Mundlapudi, Union City, CA (US); Amit Abhyankar, Hayward, CA (US)

Correspondence Address: GREGORY SMITH & ASSOCIATES, 3900 NEWPARK MALL ROAD, 3RD FLOOR, NEWARK, CA, 94560, US

(21) Appl. No.: 09/996,832

(22) Filed: Nov. 29, 2001

(51) Int. Cl. G06G 1/14; G06F 17/60

(52) U.S. Cl. 705/28

(57) ABSTRACT

An inventory management system and method for maintaining an optimal level of inventory is provided. The invention analyzes a supply chain network to provide an optimal inventory level. The invented method utilizes existing inventory information to calculate an optimal inventory level. The optimal inventory level is used to devise a purchase plan for ordering replenishment inventory. The method also incorporates intra-company lateral transfers into the inventory tracking and ordering requirements. Inventory at multiple locations is considered and used to determine whether transfers of inventory among locations can resolve inventory level issues.

### BACKGROUND OF THE INVENTION

1. Field of the Invention

The present invention relates generally to inventory management software programs and, more particularly, to a method of maintaining an optimal inventory level.

2. Description of Related Art

Both large and small companies typically have a significant portion of their assets dedicated to maintaining a desired level of inventory. If such assets could be used for purposes other than maintaining inventory, such as research and development, marketing, or other business purposes, a company could experience growth due to a more effective use of the company's assets.

Common business practice dictates that companies have available in inventory what customers may need, so that customer orders may be processed expeditiously. Accordingly, companies typically dedicate significant amounts of working capital to maintain an inventory level that ensures that customer needs are met and orders are timely processed. Should it become feasible for a company to withdraw assets previously dedicated to maintaining inventory, and utilize those assets for other business purposes, without sacrificing customer service, investors in such companies would take notice.

Optimizing inventory levels requires finding an optimal balance of inventory versus deliveries, while providing high levels of service, without adversely effecting sales, and providing good profit margins. Optimizing a supply chain may reduce costs and increase sales for companies that optimize their value chain. In order to reduce inventory to a minimum acceptable level, an analysis and determination of the optimum inventory level (i.e., minimum safety stock or safety stock) required at any particular time must be performed.

Optimization of the supply chain continues to elude many companies, since analyzing all facets of the supply chain entails thoroughly analyzing all cost links in the chain, including purchasing and carrying inventory, transportation, handling, and even administrative costs. Such a complete analysis on a day-to-day basis was unavailable in the prior art.

There are no fixed rules for selecting an appropriate approach to inventory management and determination of an optimum inventory level. The analysis depends upon the particular market or markets in which the company competes. For instance, if the market is mature where there are numerous competitors, then the cost of a lost sale resulting from a lack of inventory may be merely the lost profit that would have been made due a completed sale. In this type of market a reduction in the cost of additional inventory may be more important than a high level of customer service.

Conversely, if the market is new and there are few competitors in the market, then prompt delivery of goods and a high level of service may be necessary to acquire and increase market share. In this type of market the cost of additional inventory ready for distribution to satisfy a higher customer service requirement may be justified.

Existing inventory monitoring and replenishment computer software programs manage manufacturing processes by following raw materials and finished goods based upon equal safety stock factors for a broad range of their inventory requirements. For example, a broad group of items in inventory are reordered when their inventory minus the forecasted lead-time demand drops to a two-month supply or lower. These factors are easily monitored, due to a generally consistent pattern of the manufacturing process. The need for finished goods is relatively predictable based upon consumer needs, seasonal requirements, and requirements generated from planned promotions. Based upon the requirement for finished goods, the need for raw materials can be anticipated and replenishment needs calculated. This inventory monitoring and replenishment method is in use by an estimated 80 to 90 percent of the industry.

However, there are disadvantages to this well-known inventory monitoring and replenishment method. Firstly, this method fails to take into account several different individual variables among various items to be tracked. For example, these individual variables may include rate of defects, replenishment lead-time, service requirements, and other demand variables. Another disadvantage of the discussed prior art inventory monitoring method is that it does not adequately monitor the inconsistency of the need for spare parts (spares), sporadic need requirements referred to as “lumpy” demand (lumpy), and the consideration of lateral transfers within a company.

An example of a computerized inventory monitoring and verification system and method is disclosed in U.S. Pat. No. 5,644,725 to Schmerer. The disclosed system comprises a portable computer with a printer and modem coupled to the portable computer and maintained in a carrying case. The portable computer is configured to communicate with a mainframe computer via the modem. Dealer inventory information is stored on the mainframe computer. Dealer codes are transmitted to the mainframe computer from the portable computer to identify inventory information stored on the mainframe. Once identified, the dealer inventory information is downloaded to the portable computer. The inventory information is used to support and audit of a dealer's current inventory. The system also provides an auditor with an up-to-date record of a dealer's current inventory.

Another example is U.S. Pat. No. 5,930,770 to Edgar is directed to an inventory control system. The disclosed system includes a portable computer, a portable printer connected to the portable computer, and inventory control software stored in the portable computer.

### SUMMARY OF THE INVENTION

A preferred embodiment of the present invention comprises an inventory management system and method for maintaining an optimal level of inventory. The present invention analyzes all cost links in a supply side chain to provide an optimal balance of inventory versus deliveries. Analyzing the supply side chain provides a significant reduction of inventory levels, which leads to greater liquid assets and increased cash flow for a company utilizing the invented system.

The present invention provides an automated method of tracking and ordering inventory that is focused on four primary categories of stock in order to control the level of reliability of inventory, reduce excess inventory, and inhibit stock-outs from occurring when there is no stock of an item in inventory. The four primary categories of stock include raw materials, finished goods, spare parts, and lumpy.

A preferred method of the present invention first determines a minimum safety stock level of inventory and an optimal reorder point. Once inventory is down to the reorder point level, a new order is placed to replenish the existing stock. The minimum safety stock determination takes into account various supplier and sales related parameters and is a function of a service/performance factor k. The service/performance factor k is based upon client requirements and a reliability/variability factor σ. The reliability/variability factor σ is based upon supplier, forecast, use, and other data. The invented system provides novel methods for calculating service/performance factor k and reliability/variability factor σ based upon the requirements of one or more clients of the company and inventory data.

The preferred embodiment of the present invention utilizes a company's existing inventory information to provide a dynamic, minimum time-phased method of inventory asset management. Preferably, the invented method considers various inventory requirements, including spare parts (spares) and lumpy demand (lumpy), to calculate an optimal inventory policy (i.e., safety stock and reorder point) at which point an order must be made to replenish the inventory. The optimum inventory level limit is then used to devise a purchase plan for ordering replenishment inventory.

Additionally, the method of the present invention incorporates intra-company lateral transfers into the inventory tracking and ordering requirements. Inventory levels at multiple locations, which may comprise warehouses for example, are continuously monitored by the invented system. When the inventory level of a product or products (hereinafter product) at a particular location falls below a reorder point, the product may be replenished by ordering product directly from a contract manufacturing facility.

Moreover, the system of the present invention enables a user to first assess the inventory level of the product at each location in the system. The system determines if any locations in the system have excess inventory and if the product requires replenishment at any additional locations in the system. The system then determines which locations have excess inventory levels of the product and determines the optimal transfer quantities of the product to the appropriate locations. While transportation costs may be incurred due to transferring product between locations, the need for dedicating significant funds for maintaining a high level of inventory are obviated and balanced inventory levels at each location are maintained. When the inventory level of the product falls below the reorder point at a predetermined number of the locations in the system, the product may then be ordered from the manufacturing facility. Thus, the invented system allows the lowest possible levels of inventory, while ensuring that a minimum safety stock level is maintained.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 is a schematic view of a system architecture of a preferred embodiment of the system of the present invention; and

FIG. 2 is a flow chart of a lateral transfer module of a preferred embodiment of the method of the present invention.

### DESCRIPTION OF THE PREFERRED EMBODIMENTS

The following description is provided to enable any person skilled in the art to make and use the invention and sets forth the best modes presently contemplated by the inventors of carrying out the invention. Various modifications, however, will remain readily apparent to those skilled in the art, since the generic principles of the present invention have been defined herein.

A preferred embodiment of the present invention comprises an inventory management system and method. The invention is helpful in determining how to best fulfill a customer order, while maintaining an optimal level of inventory and providing a high level of customer service. The invention considers a number of supply-demand constraints including a variety of costs, such as production, holding, transportation, and change costs for example. The invention analyzes a supply chain network to provide an optimal balance of inventory versus deliveries.

For reference purposes only, a supply chain network may be composed of several nodes. A node is a point in the supply chain network, such as a factory, warehouse, or truck. A node may also function as a stocking location where inventory is kept. Each node in the supply chain network typically has a relationship with at least one other node in the network. One such relationship is a supplier/upstream relationship, where given a node i, node j is a supplier/upstream node if and only if product moves from j to i. Another relationship is a customer/downstream relationship, where given a node i, node j is a customer/downstream node if and only if product moves from i to j.

Another type of node relationship is a peer relationship. An example of a peer node relationship is where given a node i, node j is a peer node if and only if there is no supplier/customer relationship and nodes i and j can be substituted for each other and they are designated as such. For example, a company has two warehouses that supply computer equipment to retailers throughout the United States. One warehouse serves the eastern portion of the United States and the other warehouse serves the Western portion of the United States. In this example, the two warehouses are peer nodes if they are designated as such by the company as substitutes.

The supply chain network may have several levels. Furthermore, each level may have a supplier-customer relationship with the next level. The supplier-customer relationship could be internal or external. For example, an internal relationship is characterized by a company's set of factories supplying a product to a set of its own warehouses. An external relationship is characterized by the same set of factories supplying product to a set of warehouses owned by another company.

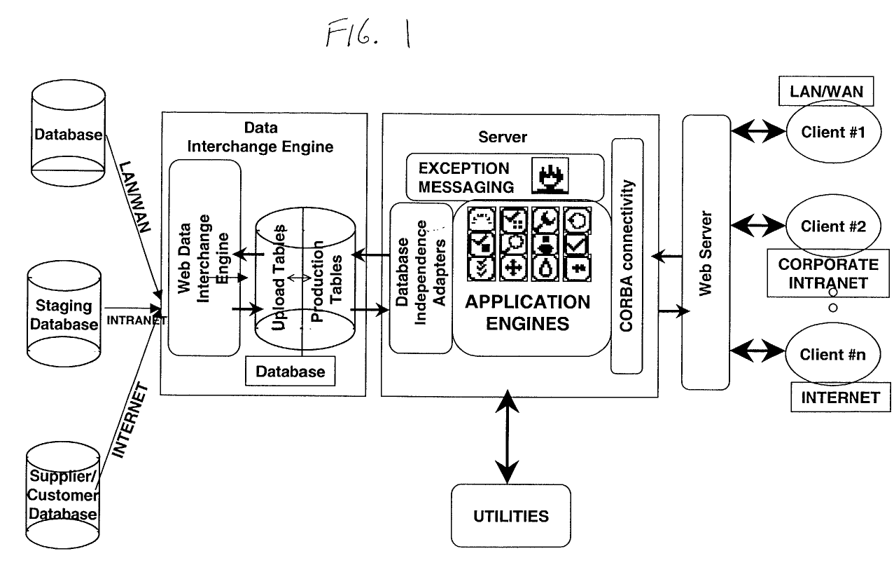

Referring now to FIG. 1 of the drawings, there is shown a preferred embodiment 10 of a system of the present invention. The system 10 includes a data module 12 coupled to a server module 14. The data module 12 may be coupled to one or more external databases 16 that provide source data to the data module 12. The external databases 16 may be electronically coupled to the data module 12 via any known means. For example, the external databases 16 may be coupled to the data module 12 via a company's Intranet, the Internet, or a LAN type network. The external databases 16 may reside at any suitable location. For example an external database 16 may reside at a location within the company or may reside at a supplier's or customer' desired location, or at an external hosting facility.

Data may be transmitted from an external database 16, or several external databases 16, to a data interchange component 18 of the data module 12. The data may be transmitted at a desired frequency. Data may be transmitted in batches, real-time, or desired combinations thereof. The interchange component 18 is configured to receive data from an external database 16 and transform the data, via known data transformation techniques such as mapping, to prepare the data for further processing. Data may be transmitted to the data module 12 via a known data markup language such as ODBC, HTTP, XML, or other well known markup languages.

Each external database 16 could have its own unique architecture. Therefore, the interchange module 18 may serves as a basic plumbing mechanism for data to flow from different types of external databases 16 to the data module 12. The interchange module 18 not only creates the data flow architecture that links the external databases 16 to the data module 12, it also enables control over the flow of data.

The data module 12 further includes a database 20 coupled to the data interchange component 18. Preferably, the database 20 is configured with an upload data portion 20A and a production data portion 20B. Data received by the interchange component 18 is transformed and mapped, then transmitted to the upload data portion 20A of the database 20. The upload portion 20A may serve as a data buffer for buffering data received from an external database 16. The upload portion 20A buffers data received from an external database 16 before the data is validated and processed by the production portion 20B. Data is automatically fed from the upload portion 20A to the production data portion 20B of the database 20. The production portion 20B automatically validates and processes the data as it is received from the upload portion 20A.

The server module 14 includes a data processing engine 22 for processing data received from the data module 12, such as data transmitted from an external database 16. The engine 22 includes at least one processor for running computer software and memory (both not shown). The memory may comprise known memory devices, data storage devices, and other known devices for storing data.

The engine 22 runs the method of the present invention (to be thoroughly discussed hereinafter) which at least in part is embodied in computer software. For example, the invented method may be implemented via a computer software program running on the server engine 22. The invented method may be configured to allow a user or users to readily access the system 10 and input and manipulate data therein. The method and system 10 may generate a user interface menu that may be displayed on a display device, such as a computer monitor (not shown). The user interface is preferably readily discernible and provides facile data input and manipulation. Preferably, the system 10 and method generate a user interface menu commonly known as a Graphical User Interface (GUI). The Graphical User Interface may comprise a graphic menu or a series of linked graphic menus that allow the user to input or manipulate data stored on a computer, as is known in the art.

The server module 14 may include a database adapter component 24 that receives data from the database 20. The primary function of the database adapter component 24 is to enable database independence. The database 20 may be implemented in practice by software purchased from a variety of vendors, such as ORACLE, SYBASE, INFORMIX, and IBM, for example. It is well known that each vendor typically has its own implementation of a database, such the database 20, and that these implementations may behave differently. The database adapter 24 ensures that the database 20 behaves as desired, regardless of the vendor supplying the software for the database 20. The database adapter 24 may be coupled to the production portion 20B of the database 20 to receive validated and processed data therefrom. Data received by the database adapter 24 is then transmitted to the engine 22 for processing by the invented method to generate data that comprises inventory information. The inventory information data is then available for use by a client/customer. A customer may obtain the inventory information via several different methods. The inventory information may be transmitted to the data module 12 and then transmitted to a customer's external database 16 using the previously discussed methods. The inventory information data may be transmitted to a customer via the Internet or other suitable network. The inventory information data may also be transmitted to the customer via the Internet by means of a known web server 26. Preferably, the web server 26 is capable of providing some level of data encryption to inhibit unwanted access to the data. Similarly, a customer may access the server module 14 to download their inventory information data via the web server 26. The customer may be allowed access to the server module 14 if they have been provided the appropriate security information, as is well known in the art. Further, the customer may access the server module 14 via known web browsers.

The server module 14 may further include a utilities module 28. The utilities module 28 may be provided to perform a number of so-called administrative tasks. For example, the utilities module 28 may provide administrative tasks such as configuring security information, activating and deactivating the server module 14, and managing users of the server module 14.

A primary focus of the preferred embodiment of the method of the present invention is to determine a minimum safety stock level of inventory. When the inventory level falls below the minimum safety stock level a determination must be made as to what comprises a best method for replenishing the inventory. The method of the present invention enables replenishing of inventory via several different methods. The invented method incorporates different modules that are designed to facilitate inventory replenishment, depending upon a number of supply chain factors. The invented method takes into account various supplier related parameters, sales related parameters, and service/performance factors that are based upon client requirements and a reliability/variability factor. The reliability/variability factor is based upon supplier, forecast, use and other data.

Lateral Transfers

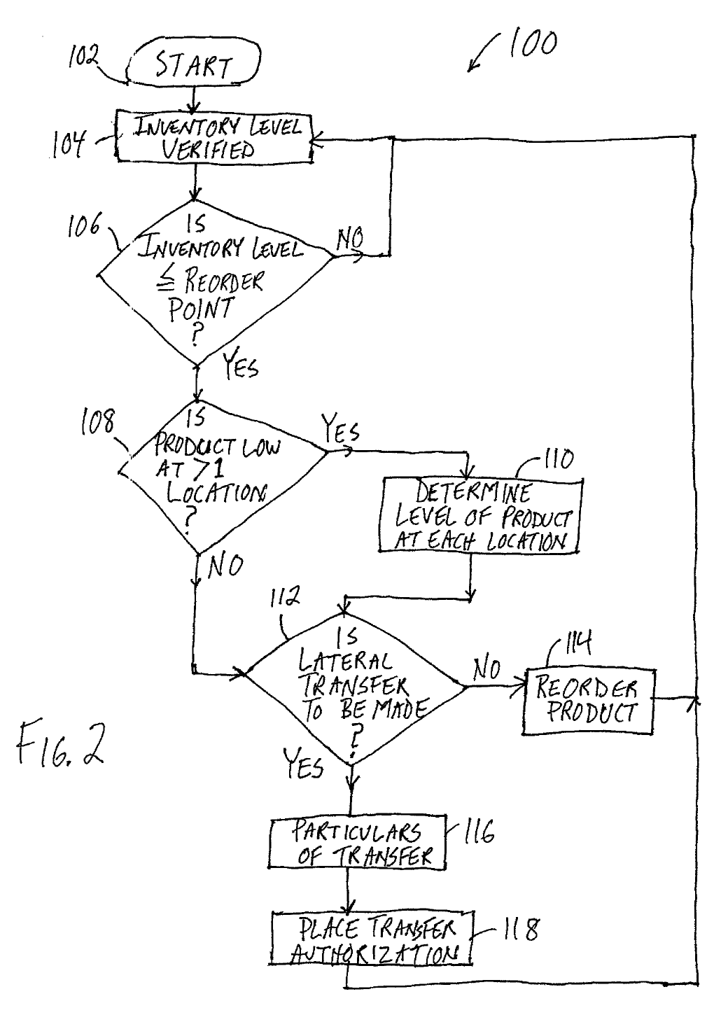

Referring to FIG. 2 of the drawings, there is shown generally at 100, a flow chart of a first module of the method of the present invention that is directed to incorporating intra-company “lateral transfers” into inventory tracking and ordering. Intra-company lateral transfers (hereafter lateral transfers) refer to the process of a company transferring product from a first, or source, location within the company to a second, or destination, location within the company. Lateral transfers allow excessive inventory residing at one or more locations within the company to be redistributed to one or more locations, also within the company, where the inventory level is at or below a reorder point. Lateral transfers allow a company to replenish inventory at certain location from inventory existing at other locations within the company to obviate the need for ordering replenishment inventory from a supplier. Thus, lateral transfers may be helpful in maintaining optimal levels of inventory within a company.

The lateral transfer process module begins at start block 102. The lateral transfer process continues to process block 104 were inventory levels are continuously verified. For example, a company may have inventory at multiple locations, such as warehouses. The inventory level at each location is continuously monitored by the lateral transfer module. In decision block 106 it is determined if the inventory level of a product at least one location has reached or fallen below a reorder point. If it is determined that the inventory level of a product at least one location has not reached or fallen below a reorder point, then the process returns to process block 104 where the inventory levels are continuously verified.

If it is determined that the inventory level of a product at least one location has reached or fallen below a reorder point, then the process continues to decision block 108. In decision block 108, it is determined if the product has reached or fallen below the reorder point at more than one location. If the product has fallen below the reorder point at more than one location, then the process continues to process block 110. In process block 110, the inventory level of that product at each monitored location is ascertained.

Once the inventory level at each location is ascertained, the process continues to decision block 112. In decision block 112 a number of decisions are made to determine if a lateral transfer of the inventory is to be made (discussed thoroughly hereinafter). Among the various considerations made, the method considers the costs associated with transporting inventory from a source location to a destination location. The method may also consider an appropriate quantity of the product, to be transferred, in order to ensure that the lateral transfer is profitable for the company. The method may also consider if it is appropriate to transfer other products simultaneously. Additionally, the invented method may consider if it is profitable to transfer product from more than one source location to more than one destination location. The method may also consider time constraints associated with transferring inventory between locations.

If it is determined, in decision block 112, that a lateral transfer is not to be made, then the process continues to process block 114 where a suitable method for replenishing the inventory is determined. Replenishment of the inventory may be made, for example, by reordering the product from a supplier or vendor. Once the product has been reordered and inventory levels have been replenished, the process of the lateral transfer module 100 returns to process block 102 where the inventory level is continuously verified.

Returning to decision block 112, if it is determined that a lateral transfer is to be made, the process continues to process block 116. In process block 116, various parameters are considered for determining the most efficient lateral transfer. The various considerations made may include the costs associated with transporting inventory from a source location to a destination location, an appropriate quantity of the product to be transferred, if other products are to be transferred simultaneously, and if product is to be transferred from more than one source location to more than one destination location. The lateral transfer module 100 may also consider time constraints associated with transferring inventory between locations.

Upon determining the particulars of the lateral transfer, in process block 118, a lateral transfer authorization is placed and product is transferred between selected locations as determined by the module 100. The process of the lateral transfer module 100 then returns to process block 102 where the inventory level is continuously verified.

Returning to decision block 108 of the lateral transfer module 100, it is determined that the product has reached or fallen below the reorder point at only one location, the process continues to decision block 112, where it is determined if a lateral transfer is to be made. As previously discussed, in decision block 112 a number of decisions are made to determine if a lateral transfer of the inventory is to be made, for replenishing the product at the particular location and if other inventory at the location requires replenishment, or if product is to be reordered from a vendor, as shown in process block 114. Upon determining if a lateral transfer is to be made and the particulars thereof, the process 100 continues to process block 118 where a lateral transfer authorization is placed and product is transferred between selected locations as determined. If it is determined that a lateral transfer is not to be made, the process continues to process block 114 where a suitable method for replenishing the inventory is determined. Once the product has been replenished, the process of the lateral transfer module 100 returns to process block 102 where the inventory level is continuously verified.

The algorithms of the lateral transfer module of a preferred embodiment of the method of the present invention are described below.

The problem presented by lateral transfers involves a network of locations as discussed above, a product requirement at one location Lᵢ (such as a customer order or a forecast), and inventory at various peer locations.

The set of peer locations that have inventory are represented as Lₘ (m=1 through n, m <>i). These peer locations could be of different types. For example, these peer locations may be finished goods warehouses that have on hand levels of inventory, repair warehouses that keep product which has been returned by the customer and repaired, factories that could build the product if needed, or alternate product lines. Alternate product lines are designated alternate products that could be used to fill demand for the given product.

Where the total quantity required at location Lᵢ is Q, the problem is to decide: How best to get this quantity Q to location Lᵢ with minimum total cost T_{C}? In other words, a set of quantities Qₘ must be determined that minimize T_{C} where:

$${\sum }_{m = 1}^{m = n} {Q}_{m} = Q$$

The Solution Algorithm

There are various approaches to solving this problem. Preferably, a greedy heuristic approach is employed as follows:

Firstly, it is assumed that ordering costs are the same at all locations. It is further assumed that ordering costs are zero (0). Putting in a fixed ordering cost is similar to putting in a minimum transfer quantity. The assumption is that the cost of moving product will more than offset the cost of ordering extra product from the vendor. This is somewhat consistent in real-world applications. The algorithm loops through the entire set of peer locations to find out where to move product.

Part 1

Starting at location Lₘ (where m=0 initially), the following are determined:

SSₘ (safety stock at Lₘ)

ROPₘ (re-order point at Lₘ)

On-handₘ (stock on hand at Lₘ)

Then, the free quantity to be moved from location Lₘ to location Lᵢ is calculated as qₘ=On-handₘ−ROPₘ. This is the maximum possible free quantity that can be moved. In the extreme case, moving all this quantity will force a reorder point at location Lₘ.

Next, a time supply of this quantity is calculated. Time supply is defined as the amount of time the given quantity will last. Looking at time supplies takes into account the forecast for that stocking location as well, where Tₘ=Time supply from quantity of qₘ.

The first point to consider is balancing order intervals. For any network to be truly balanced, it should be ensured that all nodes are being replenished at the same time. This may enable a company, or user, to take advantage of quantity discounts with a vendor. Proceeding with this assumption:

Let T_{K}=Min (Tₘ), (m=1 through n, m <>i).

Then T_{R} is selected as an agreed upon common reorder date for all locations, assuming T_{R}<=T_{K}. To balance time supplies, the quantity for each location that can be moved is equal to the following time supply:

TMOVE_{M}=Tₘ−T_{R}

Therefore, the quantity that can be moved from each location to location Lᵢ is given by Qₘ=Quantity from time supply of (TMOVE_{M})

Part 2

The second part of the algorithm has three options from which to choose. The first option is the most generic case, typically used when optimizing the replenishment date. The second option is important when there is a time constraint. For example, the product has to be received at the destination location as soon as possible to ensure minimum lead-time. The third option picks the lowest transportation cost option. In this case, it is assumed that the cost of the lateral transfer is significant and needs to be minimized.

Option 1:

Sort Qₘ in ascending order of quantity. Start picking from the lowest to highest, till

$${\sum }_{m = 1}^{m = n} {Q}_{m} <= Q$$

$$If {\sum }_{m = 1}^{m = n} {Q}_{m}$$

is strictly less than Q, then order the balance from the vendor

$${Q}_{VENDOR} = Q - {\sum }_{m = 1}^{m = n} {Q}_{m}$$

If not, then the first option of the algorithm is complete.

Option 2:

In this case, sort Qₘ in ascending order of the inter-location lead-time L_{M,I}

This enables the product to be delivered to a destination location at its earliest. Once again, start picking from the lowest to the highest as mentioned above.

Option 3:

The third option considers total transportation cost. We assume that the transportation cost model looks like this:

T_{M,I}=S_{M}+K_{M}*Qₘ

In this case, sort Qₘ in ascending order of the inter-location transportation cost T_{M,I}

The concept of this option is to get the product to the destination location, with the lowest transportation cost between locations. Once again, start picking from the lowest to the highest as mentioned above.

Thus, the algorithms for accomplishing lateral transfers have been described above. As a result, product is distributed from at least one source location to at lease one destination location. Additionally, the inventory level at each location is monitored by the invented system is re-balanced so that all locations will have to place the next order together and may be eligible for a volume discount by a vendor.

Spare Parts

A second module of a preferred embodiment of the method of the present invention provides a method of maintaining an optimal inventory level of spare parts, hereinafter referred to as spares. For purposes of discussion only, the operating life span of a component of a machine, for example, can be expressed as a random variable following exponential distribution with rate λ. Upon failure, the component must be replaced with a new component. Spare components are maintained in inventory for replacement of failed components. The spare components, or spares, may be imperfect or non-operational. Each spare in inventory, or stock, has an operational probability of p, independently of other components. When a component fails, it is successively replaced by spare components until the first operational component is found. Spare components that are examined and found non-operational during the replacement process are considered defective and discarded.

The replacement policy of the spare components may be characterized by a minimum safety stock level expressed by the variable x in the below algorithms. When the number of components in stock reaches x, a replenishment order is released, and a selected quantity (discussed hereinafter) of the components are ordered. Because the number of spare components used in each failure incident can be more than one, it is possible that at the time of a placement order, the number of units actually in stock is below x. However, to facilitate an understanding of the invention, the simplifying assumption is made that at the time of order placement the inventory level is equal to x.

The algorithms of the spares module of the preferred embodiment of the method of the present invention are as follows:

The safety stock (SS) may be defined as the product of two factors:

SS=kσ

Wherein

k is safety factor; and

σ is standard deviation over time.

A lead-time T is defined as the time interval between placement and arrival of an order, which is generally random. To facilitate analysis, a known order lead-time and constant, wherein T=t, is considered. A stockout occurs when a replacement component (i.e., spare) is needed and there are no spare items in inventory. An operational spare must then be obtained through an emergency acquisition, which may be costly. The assumption is also made that an emergency order is for one spare only and the replacement spare is operational.

The average proportion p of non-defective spares is also considered, since emergency orders are typically placed to a supplier that fulfills non-emergency orders and the emergency ordered spares have the same quality characteristics as the spare they are replacing.

Therefore, the probability of at least one stockout, the expected number of stockouts during a lead-time, as well as various fill rates, as a function of the safety stock level x must be computed.

The probability of a stockout can be expressed by the following equation:

$$P ( x ) = {\sum }_{n = 0}^{n = x} {\sum }_{j = 0}^{j = n - 1} {p}_{n} \cdot {f}_{j} ( x ) + {\sum }_{n = x + 1}^{∞} {p}_{n}$$

To simplify this equation, first,

$${p}_{n} = {p}_{n} ( t ) = {ⅇ}^{- λ t} \frac{{( λ t )}^{n}}{n !}$$

where t is the lead-time defined as the time interval between placement and arrival of an order.

The expression λt may first be calculated; such that the expression becomes λ, and the reference to the t factor is dropped.

So, the calculation for p becomes:

$${p}_{n} = {ⅇ}^{- λ} \frac{{( λ )}^{n}}{n !}$$

Where λ is understood to be during lead-time.

This formula may then be modified as follows:

$$P ( x ) = {\sum }_{n = 0}^{n = x} {\sum }_{j = 0}^{j = n - 1} {p}_{n} \cdot {f}_{j} ( x ) + ( 1 - {\sum }_{n = 0}^{x} {p}_{n} )$$

Alternatively, this formula can also be expressed as:

$$P ( x ) = {\sum }_{n = 0 }^{n = x } {p}_{n} {\sum }_{j = 0}^{j = n - 1} {f}_{j} ( x ) + ( 1 - {\sum }_{n = 0}^{n = x} {p}_{n} )$$

So, given an x, the number of spares in inventory (safety stock level), the expected probability of a stockout can be determined. This expression must be simplified in order to yield a useful, easily calculated equation. An algorithm for determining the expected probability of a stockout begins with a given value of x to calculate the probability of a stockout during lead-time. Different values of x are plugged into the equation until a satisfactory stock out probability is obtained.

In order to calculate that expression, the following expression is needed:

$${f}_{j} ( x ) = \frac{x !}{j ! ( x - j ) !} \cdot {p}^{j} \cdot {( 1 - p )}^{x - j}$$

where j<=x

Given j and x,f needs the ability to be calculated for a range of values. Both j and x will increment. f is calculated as a recursive function.

$${f}_{j + 1} ( x ) = \frac{x - j}{j + 1} \cdot \frac{p}{1 - p} \cdot {f}_{j} ( x )$$

f₀(x)=(1−p)^{x}

fₓ(x)=p^{x}

f₀(0)=1

The other dimension off is when x increases. This is expressed as:

$${f}_{j} ( x + 1 ) = \frac{x + 1}{x + 1 - j} \cdot ( 1 - p ) \cdot {f}_{j} ( x )$$

Finally, the calculation for p can also be expressed recursively.

$$\begin{matrix}{p}_{n} = {ⅇ}^{- λ} \frac{{( λ )}^{n}}{n !} \\ {p}_{n + 1} = {ⅇ}^{- λ} \frac{{( λ )}^{n + 1}}{( n + 1 ) !} = ( \frac{λ}{n + 1} ) \cdot {p}_{n} \\ {p}_{0} = {ⅇ}^{- λ}\end{matrix}$$

p₀=e^{-λ}

These parameters enable the expression for stockout probability in a recursive form to be calculated.

The following equation is first presented:

P(0)=1−p₀=1−e^{-λ}

wherein, P(0) simply represents the probability that there will be a stockout if there are no spares in inventory. This is the case, since if there is a single failure of a component, stockout situation occurs. This probability is the chance that there will be at least one failure of a component in inventory. The expression then is one (1) minus the probability that there will be no failures, hence the equation.

Given that P(x) has been calculated previously, P(x+1) may now be calculated. First, the formulae for P can be expressed as follows:

P(x)=p₁f₀(x)+p₂(f₀(x)+f₁(x))+p₃(f₀(x)+f₁(x)+f₂(x))+. . . +pₓ(f₀(x)+f₁(x)+f₂(x)+. . . +fₓ₋₁(x))+B(x)

Where B(x) is the last term as described below. Now, if x is incremented, the following formulae is generated:

P(x+1)=p₁f₀(x+1)+p₂(f₀(x+1)+f₁(x+1))+. . . +pₓ(f₀(x+1)+f₁(x+1)+. . . +fₓ₋₁(x+1))+pₓ₊₁(f₀(x+1)+. . . +fₓ₋₁(x+1)+fₓ(x+1)+B(x+1)

Based on this, there are four parts to the algorithm of calculating P(x+1) from P(x)

Part 1:

Calculate necessary new variables:

$$\begin{matrix}{p}_{x + 1} = ( \frac{λ}{x + 1} ) \cdot {p}_{x} \\ {f}_{x} ( x + 1 ) = \frac{x + 1}{x + 1 - x} \cdot ( 1 - p ) \cdot {f}_{x} ( x ) = ( x + 1 ) \cdot ( 1 - p ) \cdot {p}^{x}\end{matrix}$$

Part 2:

Increment f terms

$${f}_{j} ( x + 1 ) = \frac{x + 1}{x + 1 - j} \cdot ( 1 - p ) \cdot {f}_{j} ( x )$$

for all j ranging from 0 through x-1 (note that x was incremented above).

All inner sums based on the new f values are updated to provide the following:

f₀(x+1),(f₀(x+1)+f₁(x+1)), . . . , (f₀(x+1)+f₁(x+1)+. . . +fₓ₋₁(x+1)), (f₀(x+1)+. . . +fₓ₋₁(x+1)+fₓ(x+1)

The inner sums can be updated inside a loop, as the next f value is updated for x+1. Each inner sum is the previous inner sum plus the new value of f.

Part 3:

Calculate the first part of P(x+1) by multiplying the inner sums by the p values. The p values do not change from x to x+1.

Part 4:

A remaining p value is calculated to account for failures greater than x+1.

$${p}_{x + 1} = ( \frac{λ}{x + 1} ) \cdot {p}_{x}$$

B(x+1)=B(x)−pₓ₊₁

This provides the expression that enables the invented method to calculate stockout probability given that x spares are held in safety stock.

Next, a Fixed Stockout Cost must be determined. A first step of determining the fixed stockout cost is to calculate an expected number of stockouts. For a given quantity x of spares in safety stock, we have:

$$R ( x ) = {\sum }_{n = 0}^{n = ∞} {\sum }_{j = 0}^{j = min ( n , x )} ( n - j ) {p}_{n} {f}_{j} ( x )$$

where R(x) is the expected number of stockouts in a lead-time interval. This formula can be broken up as follows:

$$R ( x ) = {\sum }_{n = 0}^{n = x} {\sum }_{j = 0}^{j = n} ( n - j ) {p}_{n} {f}_{j} ( x ) + {\sum }_{n = x + 1}^{n = ∞} {\sum }_{j = 0}^{j = x} ( n - j ) {p}_{n} {f}_{j} ( x )$$

The main components of this formula were calculated previously. The components of this calculation can be examined as follows:

Part 1:

The inner sum is analyzed first. There are at most x terms in the inner sum. The first term will stop after we reach the value of n=x.

Part 2:

Next, the stopping criteria for the second term of the above formula is calculated. Once again, the second summation needs an infinite loop.

The loop is stopped when:

(n−j).pₙ.fⱼ(x)<ε where ε is a very small, pre-determined number (typical value for ε is 0.0001). Once again, p and f deteriorate rapidly, as compared to the growth in n−j. Stopping conditions should be reached fairly quickly.

Part 3:

As x is incremented, note that the only variable that changes is the f calculation. When x is incremented, the following new calculations are needed: f(j, x+1) for each f(j, x) where j ranges from 0 to x, and one extra term for f(x+1, x+1) which has a value of p raised to (x+1).

Then, the inner sums are incremented as in the previous calculation. The expected number of stockouts is now known for a given safety stock level. The total costs for that safety stock value may now be calculated. This is given by:

Total cost TC(x)=Ordering cost O(x)+holding cost H(x)+stockout cost S(x), where S(x)=R(x)*365/L*FSOC and where L is the lead-time in days and FSOC is the fixed cost per stockout;

$$H ( x ) = ( OQ + \frac{x}{2} ) * I * C$$

where I is the holding cost rate per year and C is the unit value of the item; and

$$O ( x ) = \frac{D}{Q} * s$$

where D is the annual demand for the product and s is the ordering cost.

So, in the final algorithm, TC(x) is calculated for every given value of x, and the x with the lowest TC(x) value is chosen as safety stock.

The computations for determining a Unit Stockout Cost are very similar to the computations used to determine fixed stockout cost. First, the expected number of items that are stocked out for a given value of the safety stock must be calculated. The total cost based on the above algorithms is then calculated. The safety stock is then determined based on the lowest total cost. The expected number of items stocked out in the case of a stock-out must then be determined.

Unit Stockout Cost per Unit Time must then be determined. The unit stockout cost per unit computations is very similar to unit stockout cost calculations, with the only difference being the calculation of the stockout cost. An expected number of items stocked out are multiplied by the average duration of a stockout. The average duration of a stockout can be calculated by noting that this is typically the emergency replenishment lead-time. In the case of a stockout, some expediting action typically is taken. The time it takes for supplies to arrive is the average duration of the stockout.

Quantity Fill Rate then needs to be determined. The algorithms for determining quantity fill rate are similar to the previous computations for determining Stockout Probability.

Expected fill rate given a current level of x spares can be expressed as:

$$EF ( x ) = {p}_{0} + {\sum }_{n = 1}^{n = x} \frac{{p}_{n}}{n} [ n + {\sum }_{j = 0}^{j = n - 1} j \cdot {f}_{j} ( x ) - n {\sum }_{j = 0}^{j = n - 1} {f}_{j} ( x ) ] + {\sum }_{j = 0}^{j = x} j \cdot {f}_{j} ( x ) {\sum }_{n = x + 1}^{n = ∞} \frac{{p}_{n}}{n}$$

As noted above, the basic expressions for all these terms earlier were computed previously. The various portion of this equation to compute quantity fill rate may be analyzed by the following computations:

Part 1:

The first term p₀ was computed above.

Part 2:

The newly added terms need to be derived.

Each term of the summation for a given value of n (ranging from 1 to the current value of x) must be analyzed:

$$Term ( n ) = \frac{{p}_{n}}{n} [ n + {\sum }_{j = 0}^{j = n - 1} j \cdot {f}_{j} ( x ) - n {\sum }_{j = 0}^{j = n - 1} {f}_{j} ( x ) ]$$

The two summations run through the same loops, with the only difference between the two summations being the first summation multiplies with the loop index. The second summation is just the sum off (although the entire sum is multiplied by n). There is also the constant n term for each Term(n). Term(n) then runs from n=1, through n=x. Since x does not get incremented in this loop from n=1, through n=x, the partial sums off (second summation) and of j times f (first summation) can be pre-calculated and stored.

Part 3:

A final summation loop is also very similar to the inner terms calculated in Part 1 and Part 2 of these quantity fill rate computations. The last inner term is at a value of x−1. This final summation happens at x, therefore, the final summation may be performed by computing one additional inner term.

Part 4:

An infinite loop must be calculated to complete the quantity fill rate algorithm. The primary difference between the quantity fill rate algorithm, and other algorithms of the present invention, is that there is an infinite loop term in the last summation. This is a static loop from x+1 to infinity, so for each value of x this is calculated only once.

Since this is an infinite loop, the term x cannot calculate exactly, therefore stopping criteria must be determined. In order to determine the stopping criteria, it must first be noted that the summation is over a term that is monotonic decreasing in n quite rapidly (n is in the denominator, as well as the fact that the probability sharply drops for high n).

The summation algorithm is stopped when:

$$\frac{{p}_{n}}{n} < ϵ$$

where ε is a very small, pre-determined number (typical value for ε is 0.0001). If λ is less than 1, then this term will decay very, very rapidly (typically in 5-6 terms.)

Lumpy Demand

A third module of the method of the preferred embodiment of the present invention is directed to “Lumpy Demand”. The lumpy demand module is designed to handle cases where the demand of product is sporadic and may vary significantly over time. For example, the lumpy demand module may be useful to manage the inventory levels of products that are normally associated with seasonal occurrences, such as holidays, or product promotions, that are not relatively consistent or readily predictable.

Prior art methods typically assume that demand (i.e., forecast error) follows a normal distribution. This method for managing lumpy demand performs poorly when there are time periods with relatively infrequent demand, and in some cases, no demand of the product. Additionally, prior art methods are prone to overestimating a level of variability of the demand for the product, or particular products, and often recommended an excessive amount of safety stock.

The invented method assumes that demands occur according to a compound Poisson distribution. The compound Poisson distribution can be described as follows: first, a number of orders occurring in any given period is determined by a Poisson distribution with a predetermined or selected rate. Second, for each order the quantity ordered is then determined by another distribution, such as by a normal distribution.

A compound Poisson distribution is advantageous since it is somewhat similar to the way demands actually occur. However, it is known that a compound Poisson distribution may be substantially difficult to manage computationally. The invented method addresses the computational problems of the compound Poisson, by making various approximations. The logic provided in the invented method delivers service levels that approximate the service target consistently through the range of practical service values (80%-100%).

The following is a discussion of input data validation, and safety stock and order point computations using an exemplary embodiment of a lumpy demand module of the method of the present invention.

The following section describes the data elements used by the lumpy demand module algorithm and the validation requirements for each element.

| Data Element | Description | Validation Rule |
|---|---|---|
| OrderQuantity | The order quantity. Computed | > = 1 |
| | from the applicable | |
| | order quantity rule. | |
| ServiceLevel | Target service level | > 0 and < 1 |
| tblDemand | Historical demand | Individual demands |
| | | should be > 0. The |
| | | table may be sparse |
| | | (individual demands |
| | | need not be included). |
| LeadTime | Replenishment lead-time | > = 0 |
| ReviewInterval | Interval between reviews. Zero | > = 0 |
| | means instantaneous review | |

Step 1

The first step is to compute the parameters of the compound Poisson distribution. These are as follows:

Rate

The Poisson rate at which orders arrive is computed as:

$$Rate = \frac{{\sum }_{Horizon} NumOrders}{NumPeriods} \qquad ( 1 )$$

Here, the Horizon is the range of time being used in the computation and NumPeriods is the number of periods in the horizon. The result should be interpreted as the order rate per period or the average number of customer orders per period. As the rate becomes small, it is possible that there will be no orders in the horizon, thus yielding a zero rate. This may be addressed by including a min rate parameter or by tracking the date of the last demand, even if the date of the last demand is outside the horizon (in this case, Rate=1/(Time Since Last Demand)) and the last known values of Mean and StdDev. The downside of these approaches is that if an item is dead (i.e. discontinued) the invented algorithm may continue to recommend safety stock for that item. This may be prevented by marking the date of the last demand of a given item.

Mean

The average (mean) quantity demanded is computed as:

$$Mean = \frac{{\sum }_{Horizon} Demand}{{\sum }_{Horizon} NumOrders} \qquad ( 2 )$$

As above, the Horizon is the range of time (dates) being used in the computation and Demand is the quantity demanded in each period.

StdDev

The standard deviation of order size, ideally, is computed as the standard deviation of the quantities demanded on the individual orders. However, the invented method can approximate it from the data available to us in tblDemand as follows:

(a) The standard deviation of Demand/NumOrders using only those periods where NumOrders>0 can be computed. In other words, the demand quantity in each period is divided by the number of orders in that period. This provides an approximate single order demand quantity. The standard deviation of these ratios, ignoring those periods where NumOrders is zero, provides the standard deviation. By ignoring the zero periods, the invented algorithm is prevented from overestimating the level of variability.

(b) If Rate>1 then multiply the standard deviation from (a) by sqrt(Rate). Otherwise, the standard deviation from (a) is the final result. This step is required because as the number of orders in each period gets larger, the Demand/NumOrder quantities become increasingly poor approximations to single orders as they will tend to regress toward the mean. This in turn causes us to underestimate the StdDev parameter. Multiplying by the square root of the rate corrects for this underestimation.

Step 2

Once the parameters of the distribution are obtained, the key components of safety stock can be computed.

Undershoot

It is well known that product orders are not always placed exactly when an inventory level reaches an order point, or projected on-hand hits safety stock in a DRP environment, particularly when demands come in quantities greater than one. To the extent that an actual order point is below, or undershoots, a planned order point, additional safety stock may be required. When the value of the undershoot is significant, as it may be in lumpy demand situations, it is important to factor the value of the undershoot into safety stock computations.

Orders are initiated by a demand. Therefore, a lead-time period begins with a demand of a product. Thus, the total demand over lead-time can be thought of as Initial Demand (occurs with certainty)+Subsequent Demands (which may or may not occur). Undershoot is a function of an initial demand, inventory position prior to the initial demand, and a review interval. In the case of continuous review, the initial demand will be a single order, but in the case of periodic review, initial demand will be the total order volume during the review interval (the initial order and any subsequent orders).

$$Undershoot = Max ( \frac{ReviewMean - 1}{2} , ReviewMean - \frac{( OrderQty - 1 )}{2} ) \qquad ( 3 )$$

Where

ReviewMean=(Rate×ReviewInterval+1)×Mean (4)

StdDev of Demand Over Lead-time

The standard deviation of demand over lead-time is computed by combining the parameters of the compound Poisson distribution with any supply variation according to the following formula:

$${StdDev}_{Total} = \sqrt{LeadTime \times Rate \times ( {Mean}^{2} + {StdDev}^{2} ) + {( LeadTime \times Rate \times Mean )}^{2} \times {StdDev}_{LT}^{2} + {StdDev}_{Order}^{2}} \qquad ( 5 )$$

Note that the variation in lead-time is not applied to the last term in Equation 5. As previously stated, the total demand over lead-time is the sum of the initial demand and any subsequent demands. Similarly, the variance over lead-time will be the sum of the variances of the initial and any subsequent demands. The variability associated with the initial demand is independent of the replenishment lead-time (thus the final term in Equation 5), while the volume, and thus the variation, of subsequent demands is clearly dependent on lead-time.

Safety Factor

The safety factor is computed according to the appropriate service rule and service level (or stock-out cost) parameters, e.g. using a known P2 rule, B1 rule, or other similar rules. No adjustment or special computation is required.

Step 3

The final outputs of the exemplary embodiment of the lumpy demand module of the method of the present invention may be computed as follows:

Safety Stock

Safety stock is computed as previously discussed, but with an adjustment for undershoot.

SafetyStock=Undershoot+SafetyFactor×StdDev_{Total} (6)

Order Point

The order point is found by adding an expected demand during lead-time to safety stock. Note that demand during the review interval is addressed by undershoot.

OrderPoint=SafetyStock+(LeadTime)×Rate×Mean (7)

Thus, the algorithms for managing lumpy demand have been described. The method of the invention uses a compound Poisson distribution to inhibit recommending excessive amounts of safety stock.

Those skilled in the art will appreciate that various adaptations and modifications of the just described preferred embodiments can be configured without departing from the scope and spirit of the invention. Therefore, it is to be understood that, within the scope of the appended claims, the invention may be practiced other than as specifically described herein.

What is claimed is:

1. A method for maintaining an optimal level of inventory comprising the following steps:
(a) determining demands on inventory residing at a location;
(b) determining an optimum level of inventory to reside at the location based upon the inventory demands;
(c) sensing the level of inventory at the location to determine if the inventory is at the optimum level;
(d) if it is determined in step c that the level of inventory is less than the optimum level, then determining a method to replenish the inventory; and
(e) if it is determined in step c that the level of inventory is greater than or equal to the optimum level, then repeating step c and subsequent steps.

2. A method for maintaining an optimal level of inventory comprising the following steps:
(a) determining a product type of a product in inventory, the inventory residing at a location;
(b) determining a demand type based on the product type of the product;
(c) determining an optimum inventory level of at least one product in inventory at the location;
(d) sensing the inventory level of at least one product in inventory at the location to determine if the inventory level of the product is at the optimum level;
(e) if it is determined in step d that the inventory level of the product is less than the optimum level, then determining a method to replenish the inventory; and
(f) if it is determined in step d that the level of inventory is greater than or equal to the optimum level, then repeating step d and subsequent steps.

3. The method of claim 2 comprising the further steps of:
(g) if it is determined in step e that the inventory requires replenishment, then determining the demand type of the product to be replenished; and
(h) determining a replenishment method based on at least the demand type of the product to be replenished.

4. A method for maintaining an optimal level of inventory comprising the following steps:
(a) determining an optimum level of at least one product in inventory of inventory residing at a first location;
(b) determining an optimum level of at least one product in inventory of inventory residing at a second location;
(c) sensing the inventory level of at least one product in inventory at the first location and the second location to determine if the inventory level of the product is less than the optimum level at either location;
(d) if it is determined in step c that the inventory level of the product is less than the optimum level at one of the first location and second location, then determining a method to replenish the inventory; and
(e) if it is determined in step c that the level of inventory is greater than or equal to the optimum level, then repeating step repeating step c and subsequent steps.

5. The method of claim 4 comprising the further steps of:
(g) if it is determined in step e that inventory requires replenishment, then determining a demand type of the product to be replenished;
(h) determining a stockout cost based on at least the demand type of the product to be replenished;
(i) determining a lead-time of replenishing the product via an inventory replenishment source.

6. The method of 5 wherein the inventory replenishment source comprises an external inventory source.

7. The method of 5 wherein the inventory replenishment source comprises an internal inventory source.

8. The method of claim 7 wherein replenishing inventory via an internal inventory source comprises the following steps:
(1) determining the inventory level of the product at the each of the first and second locations;
(2) determining a profitability level based on at least a cost of transferring inventory from the one of the first and second locations having an inventory level greater than or equal to the optimum level, to the other one of the first and second locations where the inventory level of the product is less than the optimum level;
(3) if it is determined in step 2 that the profitability level is met, then transferring inventory of the product from the one of the first and second locations having an inventory level greater than or equal to the optimum level, to the other one of the first and second locations where the inventory level of the product is less than the optimum level, to replenish the inventory; and
(4) if it is determined in step 2 that the profitability level is not met, then replenishing the inventory from an external source.

9. The method of claim 8 determining a profitability level comprising the following steps:
(a) determining the demand type of the product to be replenished; and
(b) determining a cost of transferring inventory of the product from the one of the first and second locations having an inventory level greater than or equal to the optimum level, to the other one of the first and second locations where the inventory level of the product is less than the optimum level to replenish the inventory.

10. The method of claim 9 further comprising the following step:
determining a quantity of the product to be transferred to ensure that the profitability level is met.

11. The method of claim 10 further comprising the following step:
determining a time period for transferring inventory from the one of the first and second locations having an inventory level greater than or equal to the optimum level, to the other one of the first and second locations where the inventory level of the product is less than the optimum level to ensure that the profitability level is met.

12. The method of claim 5 wherein if it is determined that the demand type is spares, then providing a method for maintaining optimum inventory level, the method of maintaining an optimum inventory level of spares comprising the following steps:
(a) determining an optimum safety stock level;
(b) determining a lead-time for replacing safety stock;
(c) locating a failed component;
(d) replacing the failed component with a spare residing in safety stock;
(e) determining if the replacement spare is defective;
(f) if the replacement spare is defective, then replacing the defective spare with subsequent spares residing in safety stock until an operational spare is discovered;
(g) sensing the safety stock level of spares to determine if the safety stock is less than the optimum level of spares;
(h) replenishing the safety stock with additional spares if the safety stock is less than the optimum level; and
(i) if the safety stock level is not less than the optimum level, then repeating step g and subsequent steps.

13. The method of claim 12 wherein in step f if no operational spare in the safety stock is discovered, then a stockout condition occurs.

14. The method of claim 13 further comprising a method for determining a probability of a stockout condition occurring, the method comprising the following steps:
determining a safety stock level;
determining a lead-time for replenishing the safety stock;
determining a rate at which spares are removed from the safety stock; and
determining if the safety stock level will be equal to zero before replenishment of the safety stock is obtained.

15. The method of claim 14 wherein the lead-time is a time interval between ordering the safety stock and obtaining the safety stock.

16. The method of claim 14 further comprising a method for determining a fixed stockout cost, the method for determining a fixed stockout cost comprising the following steps:
determining an expected amount of stockouts for a known safety stock level; and
determining a total cost of the known safety stock level.

17. The method of claim 16 further comprising a method for determining the total cost of the known safety stock level, the method comprising the following steps:
determining an ordering cost;
determining a holding cost;
determining a stockout cost; and
summing the ordering cost, the holding cost, and stockout cost to provide the total cost for the known safety stock level.

18. The method of claim 5 wherein if it is determined that the demand type is lumpy, then providing a method lumpy demand inventory replenishment comprising the following steps:
(a) determining a time period;
(b) determining an amount of inventory orders during the time period by means of performing a compound Poisson distribution with a predetermined rate; and
(c) determining a quantity of inventory in each inventory order by means of performing a normal distribution.

19. The method of claim 18 further comprising a method for determining a safety stock level of lumpy demand inventory, the method comprising the following steps:
(1) determining inventory order undershoot;
(2) determining a standard deviation over lead-time;
(3) determining a safety factor; and
(4) multiplying the standard deviation by a summation of the safety factor and the inventory order undershoot to determine the lumpy demand safety stock level.
